(19) United States
(12) Patent Application Publication
(10) Pub. No.: US 2025/0231533 A1
(43) Pub. Date: Jul. 17, 2025

(54) ELECTRONIC DEVICE FOR SEPARATING AUDIO OBJECT FROM AUDIO DATA AND CONTROL METHOD THEREOF

(71) Applicant: SAMSUNG ELECTRONICS CO., LTD., Suwon-si (KR)

(72) Inventors: Dongwoo KIM, Suwon-si (KR); Kibeom KIM, Suwon-si (KR); Sunmin KIM, Suwon-si (KR); Haekwang PARK, Suwon-si (KR); Inwoo HWANG, Suwon-si (KR)

(73) Assignee: SAMSUNG ELECTRONICS CO., LTD., Suwon-si (KR)

(21) Appl. No.: 19/097,339

(22) Filed: Apr. 1, 2025

Related U.S. Application Data
(63) Continuation of application No. PCT/KR2023/013548, filed on Sep. 11, 2023.

(30) Foreign Application Priority Data
Oct. 26, 2022 (KR) 10-2022-0139406

(51) Int. Cl. G05B 13/02; G06F 16/632

(52) U.S. Cl. CPC G05B 13/027; G06F 16/632

(57) ABSTRACT

An electronic device comprising a memory storing a neural network model; and at least one processor to convert audio data to a frequency domain, obtain encoded data by inputting the audio data converted to the frequency domain into a first layer, and obtain query data, key data, and value data by inputting the encoded data into a second layer. The processor obtains scored query data by inputting the query data into a third layer, an attention weight by calculating the element-wise product of the scored query data and the key data, context data by calculating the element-wise product of the attention weight and the value data, an object separation mask by inputting the context data and the query data into a fourth layer, and an audio object included in the audio data by converting the object separation mask to a time domain.

### CROSS-REFERENCE TO RELATED APPLICATION

This application is a continuation application is a continuation application, under 35 U.S.C. § 111 (a), of international application No. PCT/KR2023/013548, filed Sep. 11, 2023, which claims priority under 35 U. S. C. § 119 to Korean Patent Application No. 10-2022-0139406, filed Oct. 26, 2022, the disclosures of which are incorporated herein by reference in their entireties.

### Technical Field

The disclosure relates to an electronic device and a control method thereof, and more particularly, to an electronic device that separates an audio object from audio data, and a control method thereof.

### Background Art

As electronic technologies have developed, electronic devices providing various functions are being developed. In particular, recently, technics for separating an audio object such as a person's voice from audio data by utilizing various deep learning technologies are being developed.

For example, by utilizing self-attentive gated RNNs, an audio object can be separated from the past audio data of a specific time in real time. However, the latency of a network model in this case is 138 ms at the minimum, and thus there is a problem that it is difficult to apply this in a multimedia device for which latency of a very short time (within 2 ms) should be guaranteed such as a TV.

Alternatively, a voice can be reinforced in real time by reducing the calculation amount compared to a conventional convolutional neural network (CNN) and long short-term memory (LSTM) by utilizing local self-attention. However, as 29 to 32 past audio frames should be stored in real time, there is a limitation in applying this to various multimedia devices.

As can be seen above, conventional high performance audio object separation technologies based on deep learning are mostly focused on the object separation performance of the entire target audio based on a non-casual system. As a non-casual system is a structure wherein future audio data is more necessary rather than audio data of the current time point, it is structurally impossible to separate an audio object in real time.

In more recent audio object separation technologies based on deep learning for securing real time, an audio object is separated by utilizing the past audio data of a specific time. However, in this case, a memory space for utilizing the past data of a specific time should be secured, and there are various memory sizes that can be utilized depending on multimedia devices, and thus real time deep learning technologies utilizing the past data may have limitations according to characteristics of multimedia devices.

### Disclosure

### [Technical Solution]

According to an embodiment of the disclosure for achieving the aforementioned purpose, an electronic device includes memory to store a neural network model, and at least one processor to be connected with the memory and controls the electronic device. The processor may convert audio data into a frequency domain, input the audio data converted into the frequency domain into a first layer of the neural network model to obtain encoded data, input the encoded data into a second layer of the neural network model to obtain query data, key data, and value data, input the query data into a third layer of the neural network model to obtain scored query data, perform an element wise product of the scored query data and the key data to obtain an attention weight, perform an element wise product of the attention weight and the value data to obtain context data, input the context data and the query data into a fourth layer of the neural network model to obtain an object separation mask, and convert the object separation mask into a time domain to obtain an audio object included in the audio data, wherein the audio data converted into the frequency domain may be in the form of one-dimensional data, and the encoded data, the query data, the key data, the value data, the scored query data, the attention weight, and the context data may be in the form of one-dimensional data having a size that is same.

Also, the first layer may include a fully connected layer and a first activation layer, and the at least one processor may sequentially input the audio data converted into the frequency domain into the fully connected layer and the first activation layer to obtain the encoded data, and the first activation layer may be implemented as one of an ReLU or a sigmoid.

In addition, the second layer may include a query generation layer, a key generation layer, and a value generation layer, and the at least one processor may perform an element wise product of the encoded data with the query generation layer, the key generation layer, and the value generation layer to obtain the query data, the key data, and the value data.

Further, the query data may be in the form of 1×Fs, and may include Fs frequency components, and the third layer may be in the form of Fs×Fs, and the processor may input the query data into the third layer to obtain the scored query data in the form of 1×Fs, and perform an element wise product of the scored query data and the key data to obtain the attention weight based on frequency components.

Also, the at least one processor may perform an element wise product of the attention weight and the value data to obtain the context data to which weights of frequency components are reflected.

In addition, the fourth layer may include a decoding layer and a second activation layer, and the at least one processor may combine the context data and the query data to obtain combined data in the form of 1×2Fs, and sequentially input the combined data into the decoding layer and the second activation layer to obtain the object separation mask, and the second activation layer may be implemented as one of an ReLU or a sigmoid.

Further, the electronic device may further include a communication interface, and the at least one processor may, based on receiving the audio signal through the communication interface, sequentially convert time axis audio data in a predetermined number in the audio signal into the frequency domain.

Also, the at least one processor may sequentially convert the time axis audio data in the predetermined number in the audio signal into the frequency domain by overlapping the audio data in a ratio of 50%.

In addition, the at least one processor may perform fast fourier transform (FFT) of the audio data to convert the audio data into the frequency domain, and perform inverse FFT of the object separation mask to convert a mask into the time domain.

Further, the neural network model may be obtained by learning a relation between a plurality of sample audio signals and a plurality of sample audio objects, and the plurality of sample audio signals may include a sample audio object and a sample noise corresponding to the plurality of sample audio signals among the plurality of sample audio objects.

Meanwhile, according to an embodiment of the disclosure, a control method of an electronic device may include converting audio data into a frequency domain, inputting the audio data converted into the frequency domain into a first layer of a neural network model to obtain encoded data, inputting the encoded data into a second layer of the neural network model to obtain query data, key data, and value data, inputting the query data into a third layer of the neural network model to obtain scored query data, performing an element wise product of the scored query data and the key data to obtain an attention weight, performing an element wise product of the attention weight and the value data to obtain context data, inputting the context data and the query data into a fourth layer of the neural network model to obtain an object separation mask, and converting the object separation mask into a time domain to obtain an audio object included in the audio data, wherein the audio data converted into the frequency domain may be in the form of one-dimensional data, and the encoded data, the query data, the key data, the value data, the scored query data, the attention weight, and the context data may be in the form of one-dimensional data having a size that is same.

Also, the first layer may include a fully connected layer and a first activation layer, and in the obtaining the encoded data, the audio data converted into the frequency domain may be sequentially input into the fully connected layer and the first activation layer to obtain the encoded data, and the first activation layer may be implemented as one of an ReLU or a sigmoid.

In addition, the second layer may include a query generation layer, a key generation layer, and a value generation layer, and in the obtaining the query data, the key data, and the value data, an element wise product of the encoded data with the query generation layer, the key generation layer, and the value generation layer may be performed to obtain the query data, the key data, and the value data.

Further, the query data may be in the form of 1×Fs, and may include Fs frequency components, and the third layer may be in the form of Fs×Fs, and in the obtaining the scored query data, the query data may be input into the third layer to obtain the scored query data in the form of 1×Fs, and in the obtaining the attention weight, an element wise product of the scored query data and the key data may be performed to obtain the attention weight based on frequency components.

Also, in the obtaining the context data, an element wise product of the attention weight and the value data may be performed to obtain the context data to which weights of frequency components are reflected.

In addition, the fourth layer may include a decoding layer and a second activation layer, and in the obtaining the object separation mask, the context data and the query data may be combined to obtain combined data in the form of 1×2Fs, and the combined data may be sequentially input into the decoding layer and the second activation layer to obtain the object separation mask, and the second activation layer may be implemented as one of an ReLU or a sigmoid.

Further, the control method may further include the receiving the audio signal, and in the converting, time axis audio data in a predetermined number in the audio signal may be sequentially converted into the frequency domain.

Also, in the converting, the time axis audio data in the predetermined number in the audio signal may be sequentially converted into the frequency domain by overlapping the audio data in a ratio of 50%.

In addition, in the converting, fast fourier transform (FFT) of the audio data may be performed to convert the audio data into the frequency domain, and in the obtaining the audio object, inverse FFT of the object separation mask may be performed to convert a mask into the time domain.

Further, the neural network model may be obtained by learning a relation between a plurality of sample audio signals and a plurality of sample audio objects, and the plurality of sample audio signals may include a sample audio object and a sample noise corresponding to the plurality of sample audio signals among the plurality of sample audio objects.

### DESCRIPTION OF DRAWINGS

FIG. 1 is a block diagram illustrating a configuration of an electronic device according to an embodiment of the disclosure;

FIG. 2 is a block diagram illustrating a detailed configuration of an electronic device according to an embodiment of the disclosure;

FIG. 3 is a diagram for illustrating on the whole a method of obtaining an audio object according to an embodiment of the disclosure;

FIG. 4 is a diagram for illustrating a method of obtaining encoded data according to an embodiment of the disclosure;

FIG. 5 is a diagram for illustrating a method of obtaining query data, key data, and value data according to an embodiment of the disclosure;

FIG. 6 is a diagram for illustrating a method of obtaining an attention weight according to an embodiment of the disclosure by comparing the method with a conventional technology;

FIG. 7 is a diagram for illustrating a method of obtaining context data according to an embodiment of the disclosure;

FIG. 8 is a diagram for illustrating a method of obtaining an object separation mask according to an embodiment of the disclosure; and

FIG. 9 is a flow chart for illustrating a control method of an electronic device according to an embodiment of the disclosure.

### MODE FOR INVENTION

The purpose of the disclosure is in providing an electronic device that can separate an audio object in real time with high performance by using single frame audio data of the current time section, and a control method thereof.

Hereinafter, the disclosure will be described in detail with reference to the accompanying drawings.

As terms used in the embodiments of the disclosure, general terms that are currently used widely were selected as far as possible, in consideration of the functions described in the disclosure. However, the terms may vary depending on the intention of those skilled in the art who work in the pertinent field or previous court decisions, or emergence of new technologies, etc. Also, in particular cases, there may be terms that were designated by the applicant on his own, and in such cases, the meaning of the terms will be described in detail in the relevant descriptions in the disclosure. Accordingly, the terms used in the disclosure should be defined based on the meaning of the terms and the overall content of the disclosure, but not just based on the names of the terms.

In addition, in this specification, expressions such as “have,” “may have,” “include” and “may include” should be construed as denoting that there are such characteristics (e.g.: elements such as numerical values, functions, operations, and components), and the expressions are not intended to exclude the existence of additional characteristics.

Further, the expression “at least one of A and/or B” should be interpreted to mean any one of “A” or” B″ or “A and B.”

Also, the expressions “first,” “second,” and the like used in this specification may describe various elements regardless of any order and/or degree of importance. Further, such expressions are used only to distinguish one element from another element, and are not intended to limit the elements.

In addition, singular expressions include plural expressions, as long as they do not obviously mean differently in the context. Also, in the disclosure, terms such as “include” and “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components or a combination thereof.

Further, in this specification, the term “user” may refer to a person who uses an electronic device or a device using an electronic device (e.g.: an artificial intelligence electronic device).

Hereinafter, various embodiments of the disclosure will be described in more detail with reference to the accompanying drawings.

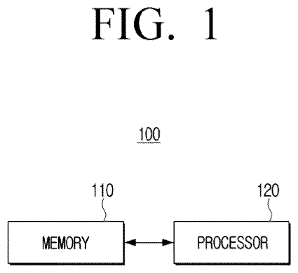

FIG. 1 is a block diagram illustrating a configuration of an electronic device 100 according to an embodiment of the disclosure.

The electronic device 100 may obtain an audio object from audio data. For example, the electronic device 100 may be implemented as a main body of a computer, a set-top box (STB), a server, an AI speaker, a TV, a desktop PC, a laptop, a smartphone, a tablet PC, smart glasses, a smart watch, etc., and obtain an audio object from audio data.

However, the disclosure is not limited thereto, and any device that can obtain an audio object from audio data can be the electronic device 100.

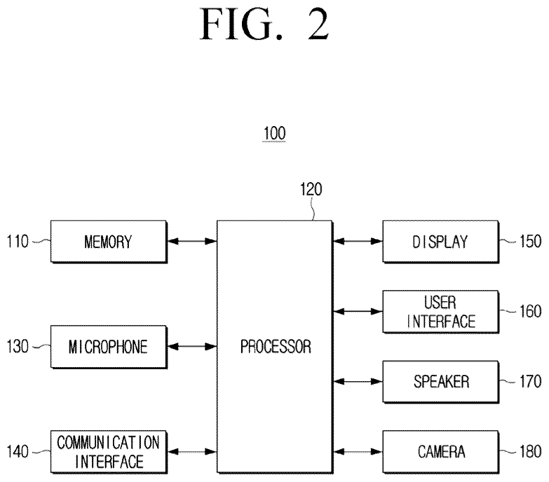

According to FIG. 2, the electronic device 100 includes memory 110 and a processor 120.

The memory 110 may refer to hardware that stores information such as data, etc. in an electric or a magnetic form so that the processor 120, etc. can access the information. For this, the memory 110 may be implemented as at least one hardware among non-volatile memory, volatile memory, flash memory, a hard disk drive (HDD) or a solid state drive (SSD), RAM, ROM, etc.

In the memory 110, at least one instruction necessary for the operations of the electronic device 100 or the processor 120 may be stored. Here, an instruction is a code unit instructing the operation of the electronic device 100 or the processor 120, and it may have been drafted in a machine language which is a language that can be understood by a computer. Alternatively, in the memory 110, a plurality of instructions that perform specific tasks of the electronic device 100 or the processor 120 may be stored as an instruction set.

In the memory 110, data which is information in bit or byte units that can indicate characters, numbers, images, etc. may be stored. For example, in the memory 110, a neural network model, etc. may be stored.

The memory 110 may be accessed by the processor 120, and reading/recording/correction/deletion/update, etc. for an instruction, an instruction set, or data may be performed by the processor 120.

The processor 120 controls the overall operations of the electronic device 100. Specifically, the processor 120 may be connected with each component of the electronic device 100, and control the overall operations of the electronic device 100. For example, the processor 120 may be connected with components such as the memory 110, a microphone (not shown), a communication interface (not shown), etc., and control the operations of the electronic device 100.

The at least one processor 120 may include one or more of a central processing unit (CPU), a graphics processing unit (GPU), an accelerated processing unit (APU), a many integrated core (MIC), a neural processing unit (NPU), a hardware accelerator, or a machine learning accelerator. The at least one processor 120 may control one or a random combination of the other components of the electronic device 100, and perform an operation related to communication or data processing. Also, the at least one processor 120 may execute one or more programs or instructions stored in the memory. For example, the at least one processor 120 may perform the method according to an embodiment of the disclosure by executing the at least one instruction stored in the memory.

In case the method according to an embodiment of the disclosure includes a plurality of operations, the plurality of operations may be performed by one processor, or performed by a plurality of processors. For example, when a first operation, a second operation, and a third operation are performed by the method according to an embodiment, all of the first operation, the second operation, and the third operation may be performed by a first processor, or the first operation and the second operation may be performed by the first processor (e.g., a generic-purpose processor), and the third operation may be performed by a second processor (e.g., an artificial intelligence-dedicated processor).

The at least one processor 120 may be implemented as a single core processor including one core, or may be implemented as one or more multicore processors including a plurality of cores (e.g., multicores of the same kind or multicores of different kinds). In case the at least one processor 120 is implemented as multicore processors, each of the plurality of cores included in the multicore processors may include internal memory of the processor such as cache memory, on-chip memory, etc., and common cache shared by the plurality of cores may be included in the multicore processors. Also, each of the plurality of cores (or some of the plurality of cores) included in the multicore processors may independently read a program instruction for implementing the method according to an embodiment of the disclosure and perform the instruction, or the plurality of entire cores (or some of the cores) may be linked with one another, and read a program instruction for implementing the method according to an embodiment of the disclosure and perform the instruction.

In case the method according to an embodiment of the disclosure includes a plurality of operations, the plurality of operations may be performed by one core among the plurality of cores included in the multicore processors, or they may be performed by the plurality of cores. For example, when the first operation, the second operation, and the third operation are performed by the method according to an embodiment, all of the first operation, the second operation, and the third operation may be performed by a first core included in the multicore processors, or the first operation and the second operation may be performed by the first core included in the multicore processors, and the third operation may be performed by a second core included in the multicore processors.

In the embodiments of the disclosure, the at least one processor 120 may mean a system on chip (SoC) wherein at least one processor and other electronic components are integrated, a single core processor, a multicore processor, or a core included in the single core processor or the multicore processor. Also, here, the core may be implemented as a CPU, a GPU, an APU, a MIC, an NPU, a hardware accelerator, or a machine learning accelerator, etc., but the embodiments of the disclosure are not limited thereto. However, hereinafter, operations of the electronic device 100 will be explained with the expression “the processor 120,” for the convenience of explanation.

The processor 120 may convert audio data into a frequency domain. For example, the processor 120 may perform fast fourier transform (FFT) of audio data to convert the audio data into a frequency domain. The audio data converted into a frequency domain may be in the form of one-dimensional data.

Here, the electronic device 100 may further include a communication interface, and when an audio signal is sequentially received through the communication interface, the processor 120 may sequentially convert time axis audio data in a predetermined number in the audio signal into a frequency domain. For example, the processor 120 may convert 512 pieces of audio data into a frequency domain. In case an audio signal is 44 kHz, 512 pieces of audio data are merely about 0.011 second, and as the processor 120 uses only the audio data of a very short time section, real time processing is possible, and a storage space for storing the past audio data is unnecessary.

The processor 120 may sequentially convert the time axis audio data in the predetermined number in the audio signal into a frequency domain by overlapping the audio data in a ratio of 50%. For example, the processor 120 may convert the 512 pieces of audio data in the first time section into a frequency domain, and if 256 pieces of audio data are additionally received right after the first time section, the processor 120 may convert the recent 256 pieces of audio data of the first time section and the additionally received 256 pieces of audio data into a frequency domain.

However, the disclosure is not limited thereto, and the processor 120 may convert audio data in any various numbers into a frequency domain. Also, the processor 120 may convert audio data into a frequency domain in any various overlapping ratios. In addition, the electronic device 100 may further include a microphone, and when an audio signal is obtained through the microphone, the processor 120 may sequentially convert the time axis audio data in the predetermined number in the audio signal into a frequency domain.

The processor 120 may input the audio data converted into a frequency domain into a first layer of the neural network model stored in the memory 110 to obtain encoded data. For example, the first layer may include a fully connected layer and a first activation layer, and the processor 120 may sequentially input the audio data converted into a frequency domain into the fully connected layer and the first activation layer to obtain encoded data. The first activation layer may be implemented as one of an ReLU or a sigmoid.

The processor 120 may input the encoded data into a second layer of the neural network model to obtain query data, key data, and value data. For example, the second layer may include a query generation layer, a key generation layer, and a value generation layer, and the processor 120 may perform an element wise product of the encoded data with each of the query generation layer, the key generation layer, and the value generation layer to obtain the query data, the key data, and the value data.

The processor 120 may input the query data into a third layer of the neural network model to obtain scored query data, and perform an element wise product of the scored query data and the key data to obtain an attention weight. For example, the query data may be in the form of 1×Fs, and include Fs frequency components, and the third layer may be in the form of Fs×Fs, and the processor 120 may input the query data into the third layer to obtain the scored query data in the form of 1×Fs, and perform an element wise product of the scored query data and the key data to obtain the attention weight based on frequency components.

The processor 120 may perform an element wise product of the attention weight and the value data to obtain context data. For example, the processor 120 may perform an element wise product of the attention weight and the value data to obtain context data to which weights of frequency components are reflected.

The processor 120 may input the context data and the query data into a fourth layer of the neural network model to obtain an object separation mask. For example, the fourth layer may include a decoding layer and a second activation layer, and the processor 120 may combine the context data and the query data to obtain combined data in the form of 1×2Fs, and sequentially input the combined data into the decoding layer and the second activation layer to obtain the object separation mask. Here, the second activation layer may be implemented as one of an ReLU or a sigmoid.

The processor 120 may convert the object separation mask into a time domain to obtain an audio object included in the audio data. For example, the processor 120 may perform inverse FFT of the object separation mask to convert the mask into the time domain.

The encoded data, the query data, the key data, the value data, the scored query data, the attention weight, and the context data mentioned above may be in the form of one-dimensional data in the same size.

The neural network model may be a model that was obtained by learning a relation between a plurality of sample audio signals and a plurality of sample audio objects, and each of the plurality of sample audio signals may include a sample audio object and a sample noise corresponding to each of the plurality of sample audio signals among the plurality of sample audio objects. That is, the first network, the second network, the third network, and the fourth network included in the neural network model may be trained based on the plurality of sample audio signals and the plurality of sample audio objects.

Meanwhile, functions related to artificial intelligence according to the disclosure may be operated through the processor 120 and the memory 110.

The processor 120 may consist of one or a plurality of processors. Here, the one or plurality of processors may be generic-purpose processors such as a CPU, an AP, a DSP, etc., graphic-dedicated processors such as a GPU and a vision processing unit (VPU), or artificial intelligence-dedicated processors such as an NPU.

The one or plurality of processors perform control to process input data according to predefined operation rules or an artificial intelligence model stored in the memory 110. Alternatively, in case the one or plurality of processors are artificial intelligence-dedicated processors, the artificial intelligence-dedicated processors may be designed as a hardware structure specific for processing of a specific artificial intelligence model. The predefined operation rules or the artificial intelligence model are characterized in that they are made through learning.

Here, being made through learning means that a basic artificial intelligence model is trained by using a plurality of training data by a learning algorithm, and predefined operation rules or an artificial intelligence model set to perform desired characteristics (or, purposes) are thereby made. Such learning may be performed in a device itself wherein artificial intelligence is performed according to the disclosure, or through a separate server and/or a separate system. As examples of learning algorithms, there are supervised learning, unsupervised learning, semi-supervised learning, or reinforcement learning, but learning algorithms in the disclosure are not limited to the aforementioned examples.

An artificial intelligence model may consist of a plurality of neural network layers. Each of the plurality of neural network layers has a plurality of weight values, and performs a neural network operation through an operation result of the previous layer and an operation among the plurality of weight values. The plurality of weight values included by the plurality of neural network layers may be optimized by the learning result of the artificial intelligence model. For example, the plurality of weight values may be updated such that a loss value or a cost value obtained at the artificial intelligence model during a learning process is reduced or minimized.

An artificial neural network may include a deep neural network (DNN), and there are, for example, a convolutional neural network (CNN), a deep neural network (DNN), a recurrent neural network (RNN), a restricted Boltzmann Machine (RBM), a deep belief network (DBN), a bidirectional recurrent deep neural network (BRDNN), a generative adversarial network (GAN), or deep Q-networks, etc., but the disclosure is not limited to the aforementioned examples.

FIG. 2 is a block diagram illustrating a detailed configuration of the electronic device 100 according to an embodiment of the disclosure.

FIG. 2 is a block diagram illustrating a detailed configuration of the electronic device 100 according to an embodiment of the disclosure. The electronic device 100 may include memory 110 and the processor 120. Also, according to FIG. 2, the electronic device 100 may further include a microphone 130, a communication interface 140, a display 150, a user interface 160, a speaker 170, and a camera 180. Among the components illustrated in FIG. 2, regarding parts overlapping with the components illustrated in FIG. 1, detailed explanation will be omitted.

The microphone 130 is a component for receiving input of a sound and converting it into an audio signal. The microphone 130 may be electrically connected with the processor 120, and receive a sound by control by the processor 120.

For example, the microphone 130 may be formed as an integrated type integrated to the upper side or the front surface direction, the side surface direction, etc. of the electronic device 100. Alternatively, the microphone 130 may be provided on a remote control, etc. separate from the electronic device 100. In this case, the remote control may receive a sound through the microphone 130, and provide the received sound to the electronic device 100.

The microphone 130 may include various components such as a microphone collecting a sound in an analogue form, an amp circuit amplifying the collected sound, an A/D conversion circuit that samples the amplified sound and converts the sound into a digital signal, a filter circuit that removes noise components from the converted digital signal, etc.

Meanwhile, the microphone 130 may also be implemented in the form of a sound sensor, and it can be of any type if it is a component that can collect sounds.

The communication interface 140 is a component performing communication with various types of external devices according to various types of communication methods. For example, the electronic device 100 may perform communication with a content server or a user terminal device through the communication interface 140.

The communication interface 140 may include a Wi-Fi module, a Bluetooth module, an infrared communication module, a wireless communication module, etc. Here, each communication module may be implemented in the form of at least one hardware chip.

A Wi-Fi module and a Bluetooth module perform communication by a Wi-Fi method and a Bluetooth method, respectively. In the case of using a Wi-Fi module or a Bluetooth module, various types of connection information such as an SSID and a session key is transmitted and received first, and connection of communication is performed by using the information, and various types of information can be transmitted and received thereafter. An infrared communication module performs communication according to an infrared Data Association (IrDA) technology of transmitting data to a near field wirelessly by using infrared rays between visible rays and millimeter waves.

A wireless communication module may include at least one communication chip that performs communication according to various wireless communication protocols such as Zigbee, 3rd Generation (3G), 3rd Generation Partnership Project (3GPP), Long Term Evolution (LTE), LTE Advanced (LTE-A), 4th Generation (4G), 5th Generation (5G), etc. other than the aforementioned communication methods.

Alternatively, the communication interface 140 may include a wired communication interface such as an HDMI, a DP, a Thunderbolt, a USB, an RGB, a D-SUB, a DVI, etc.

Other than the above, the communication interface 140 may include at least one of a local area network (LAN) module, an Ethernet module, or a wired communication module that performs communication by using a pair cable, a coaxial cable, or an optical fiber cable, etc.

The display 150 is a component displaying images, and may be implemented as various forms of displays such as a liquid crystal display (LCD), an organic light emitting diodes (OLED) display, a plasma display panel (PDP), etc. In the display 150, a driving circuit that may be implemented in forms such as an a-si TFT, a low temperature poly silicon (LTPS) TFT, an organic TFT (OTFT), etc., and a backlight unit, etc. may also be included together. Meanwhile, the display 150 may be implemented as a touch screen combined with a touch sensor, a flexible display, a 3D display, etc.

The user interface 160 may be implemented as a button, a touch pad, a mouse, and a keyboard, etc., or as a touch screen that can perform both of a display function and a manipulation input function. Here, a button may be various types of buttons such as a mechanical button, a touch pad, a wheel, etc. formed in any areas such as the front surface part, the side surface part, the rear surface part, etc. of the exterior of the main body of the electronic device 100.

The speaker 170 is a component that outputs not only various kinds of audio data processed at the processor 120, but also various kinds of notification sounds or voice messages, etc.

The camera 180 is a component for photographing a still image or a moving image. The camera 180 may photograph a still image on a specific time point, but may also photograph still images consecutively.

The camera 180 includes a lens, a shutter, a diaphragm, a solid imaging element, an analog front end (AFE), and a timing generator (TG). The shutter adjusts the time when a light reflected on a subject enters the camera 180, and the diaphragm adjusts the amount of the light introduced into the lens by mechanically increasing or decreasing the size of the opening through which the light enters. When the light reflected on the subject is accumulated as photo charges, the solid imaging element outputs the phase due to the photo charges as an electric signal. The TG outputs a timing signal for reading out the pixel data of the solid imaging element, and the AFE samples and digitalizes the electric signal output from the solid imaging element.

As described above, the electronic device 100 can separate an audio object in real time with high performance by using single frame audio data of the current time section. Also, the electronic device 100 can separate an audio object in real time without a limitation on hardware characteristics, and can reduce the manufacturing cost and improve the operation speed.

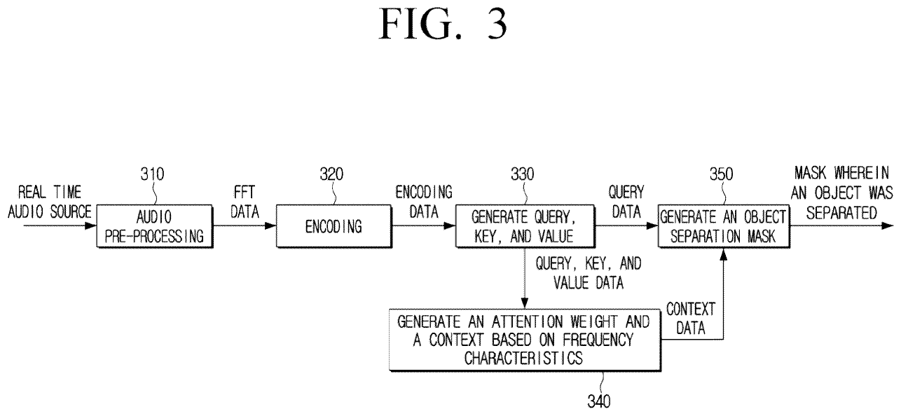

Hereinafter, operations of the electronic device 100 will be described in more detail through FIG. 3 to FIG. 8. In FIG. 3 to FIG. 8, individual embodiments will be explained for the convenience of explanation. However, the individual embodiments in FIG. 3 to FIG. 8 may be carried out in any combined states.

FIG. 3 is a diagram for illustrating on the whole a method of obtaining an audio object according to an embodiment of the disclosure.

The processor 120 may perform audio pre-processing from an audio signal (310). For example, the processor 120 may sequentially convert time axis audio data in the predetermined number in the audio signal into a frequency domain.

The processor 120 may perform FFT of the audio data to convert the audio data into a frequency domain. However, the disclosure is not limited thereto, and any method that can convert audio data into a frequency domain can be used.

The processor 120 may encode the audio data converted into a frequency domain to obtain encoded data (320). For example, the processor 120 may input the audio data converted into a frequency domain into the first layer of the neural network model to obtain encoded data.

The processor 120 may obtain query data, key data, and value data from the encoded data (330). For example, the processor 120 may input the encoded data into the second layer of the neural network model to obtain query data, key data, and value data.

The processor 120 may obtain an attention weight and context data by using the query data, the key data, and the value data (340). For example, the processor 120 may input the query data into the third layer of the neural network model to obtain scored query data, and perform an element wise product of the scored query data and the key data to obtain an attention weight, and perform an element wise product of the attention weight and the value data to obtain context data.

The processor 120 may obtain an object separation mask by using the context data and the query data (350). For example, the processor 120 may input the context data and the query data into the fourth layer of the neural network model to obtain an object separation mask.

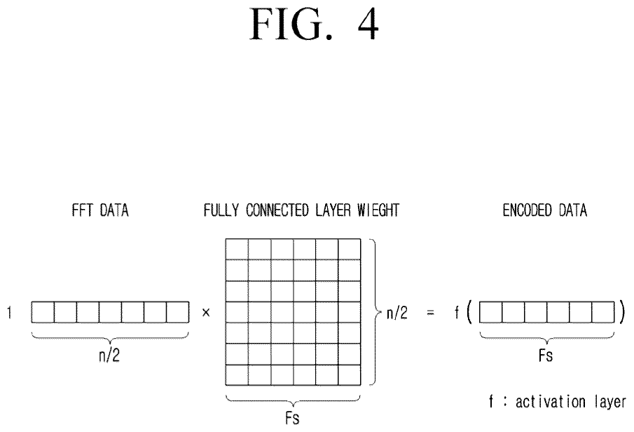

FIG. 4 is a diagram for illustrating a method of obtaining encoded data according to an embodiment of the disclosure.

The processor 120 may perform FFT of time axis audio data in a predetermined number in an audio signal to sequentially convert the audio data into a frequency domain. For example, the processor 120 may sequentially convert time axis audio data in a predetermined number n in an audio signal into a frequency domain by overlapping the audio data in a ratio of 50%.

In this case, the audio data converted into a frequency domain may be converted into an n/2 length as illustrated in FIG. 4. Here, n/2 may be the number of frequency bins. That is, the audio data converted into a frequency domain may be in the form of a vector of 1×n/2.

The processor 120 may input the audio data converted into a frequency domain into the first layer of the neural network model to obtain encoded data. For example, the first layer may include a fully connected layer in the form of a matrix of n/2×Fs and a first activation layer, and the processor 120 may input the audio data converted into a frequency domain into the fully connected layer and encode the audio data in a desired state length (Fs), and input the audio data into the first activation layer to obtain encoded data. Here, the first activation layer may be implemented as one of an ReLU or a sigmoid.

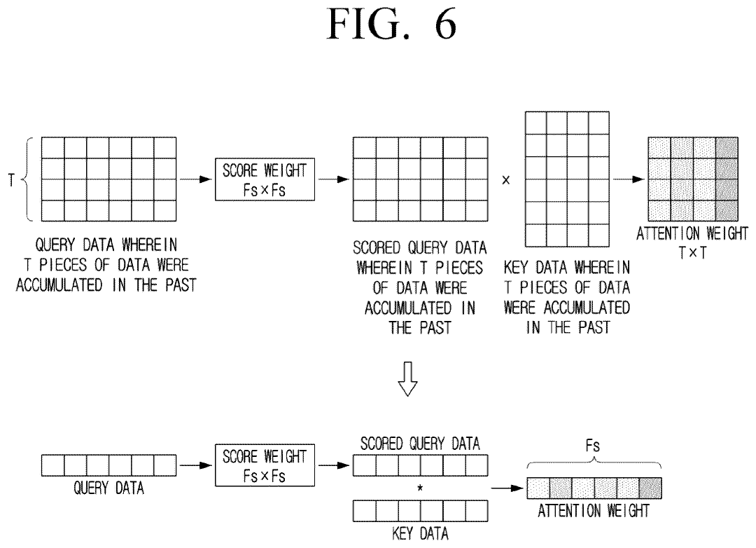

In this case, the encoded data may be in the form of a vector of 1×Fs. Here, it can be deemed that each element includes only a frequency component without a time component, and explanation in this regard will be described by comparing it with a conventional technology in FIG. 6.

The encoded data may be used as an input value of the query generation layer, the key generation layer, and the value generation layer.

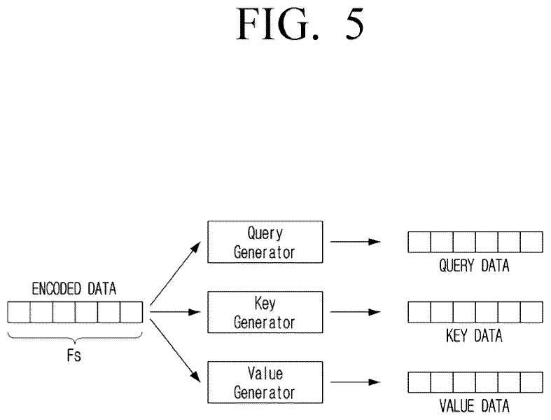

FIG. 5 is a diagram for illustrating a method of obtaining query data, key data, and value data according to an embodiment of the disclosure.

The processor 120 may input encoded data in the form of a vector of 1×Fs into the second layer of the neural network model to obtain query data, key data, and value data. For example, the second layer may include a query generation layer, a key generation layer, and a value generation layer, and as illustrated in FIG. 5, the processor 120 may perform an element wise product of the encoded data with each of the query generation layer, the key generation layer, and the value generation layer to obtain the query data, the key data, and the value data. Here, each of the query generation layer, the key generation layer, and the value generation layer may be in the form of a vector of 1×Fs.

Due to the element wise product, each data is multiplied between elements, and thus each of the query data, the key data, and value data may be in the form of a vector of 1×Fs.

FIG. 6 is a diagram for illustrating a method of obtaining an attention weight according to an embodiment of the disclosure by comparing the method with a conventional technology.

The processor 120 may input the query data into the third layer of the neural network model to obtain scored query data, and perform an element wise product of the scored query data and the key data to obtain an attention weight. For example, as illustrated in the lower part of FIG. 6, the processor 120 may input the query data into the third layer (a score weight) in the form of a matrix of FsxFs to obtain scored query data in the form of a vector of 1×Fs, and perform an element wise product of the scored query data and the key data to obtain an attention weight based on frequency components. As each element of the query data also includes only a frequency component without a time component, each element of the attention weight after an operation with the third layer and the key data may also include only a frequency component without a time component.

Comparing this to a conventional technology as in the upper part of FIG. 6, the conventional technology uses data of a T time section. Specifically, the operation from FIG. 4 to FIG. 5 may be, for example, an operation of processing 512 pieces of audio data of the first time section from 0 second to about 0.011 second. In this regard, in the conventional technology, for example, 512 pieces of audio data of the first time section from 0 second to about 0.011 second, 512 pieces of audio data of the second time section after the first time section, 512 pieces of audio data of the third time section after the second time section, and 512 pieces of audio data of the fourth time section after the third time section may be processed by the method as in FIG. 4 to FIG. 5 to obtain query data in the form of a matrix as in the upper left part of FIG. 6. Here, in the method as in FIG. 4 to FIG. 5, a linear operation is possible, and thus the audio data of the four time sections may not influence one another.

However, in the upper part of FIG. 6, if the query data of the conventional technology is input into the third layer (a score weight) in the form of a matrix of Fs×Fs, time components get to influence one another. Also, for an output of the third layer, a general matrix multiplication operation, but not an element wise product, is performed with the transposed key data, and in this case, time components also get to influence one another.

That is, the conventional technology uses correlation among time components through such an operation, and accordingly, it is necessary that the past data is stored. In this regard, according to the disclosure, correlation among time components is not used, but correlation among frequency components is used. This is expressed as proceeding with an attention of the frequency components, but not an attention of the time axis data.

It can be deemed that the attention weight of T×T in the conventional technology includes time components in both of its horizontal and vertical directions, but it can be deemed that each element of the attention weight of 1×Fs in the disclosure includes a frequency component.

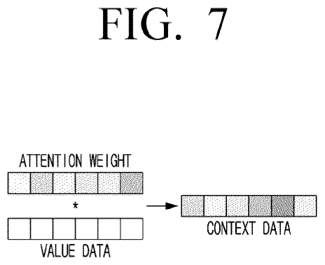

FIG. 7 is a diagram for illustrating a method of obtaining context data according to an embodiment of the disclosure.

The processor 120 may perform an element wise product of the attention weight and the value data to obtain context data. For example, as illustrated in FIG. 7, the processor 120 may perform an element wise product of the attention weight and the value data to obtain context data to which weights of frequency components are reflected.

According to the conventional technology, a general matrix multiplication operation, but not an element wise product, is performed between the attention weight of T×T and the key data of T×Fs, and in this case, it can be also deemed that correlation among the time components is applied.

As described above, in the disclosure, an attention weight and context data are generated by considering only frequency components without considering time components, and thus it is possible to separate an audio object with high performance without using the past data. Also, as the past data is not used, there is an advantage that separation of an audio object in real time is possible.

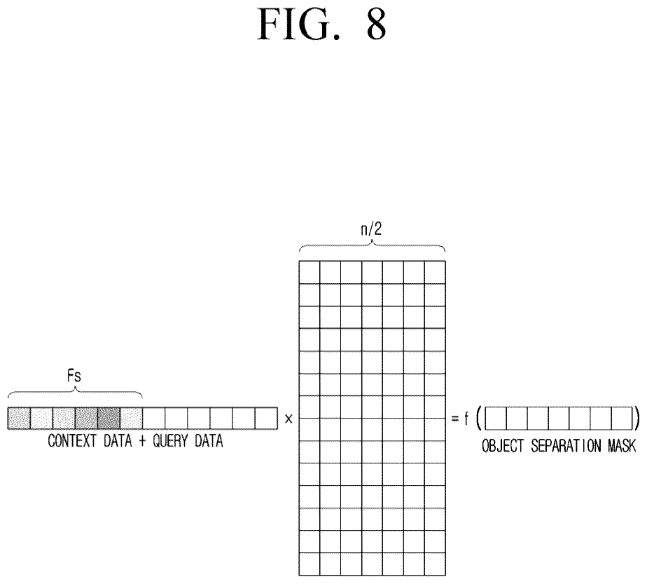

FIG. 8 is a diagram for illustrating a method of obtaining an object separation mask according to an embodiment of the disclosure.

The processor 120 may input the context data and the query data into the fourth layer of the neural network model to obtain an object separation mask. For example, the fourth layer may include a decoding layer and a second activation layer, and as illustrated in FIG. 8, the processor 120 may combine the context data and the query data to obtain combined data in the form of 1×2Fs, and sequentially input the combined data into the decoding layer and the second activation layer to obtain an object separation mask. Here, the second activation layer may be implemented as one of an ReLU or a sigmoid.

In this case, the object separation mask may be in the form of a vector of 1×n/2.

The processor 120 may convert the object separation mask into a time domain to obtain an audio object included in the audio data. For example, the processor 120 may perform inverse FFT of the object separation mask to convert the mask into the time domain.

In this case, the audio object may be time axis data of a predetermined number (n).

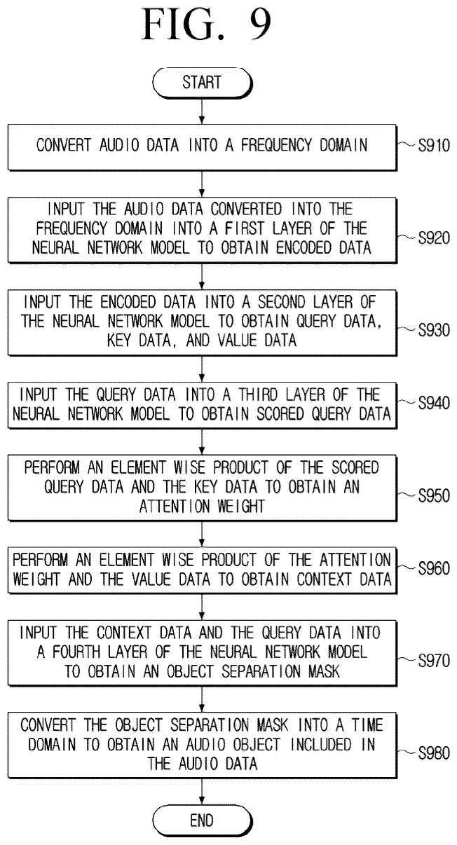

FIG. 9 is a flow chart for illustrating a control method of an electronic device according to an embodiment of the disclosure.

First, audio data is converted into a frequency domain in the operation S910. Then, the audio data converted into the frequency domain is input into a first layer of the neural network model to obtain encoded data in the operation S920. Then, the encoded data is input into a second layer of the neural network model to obtain query data, key data, and value data in the operation S930. Then, the query data is input into a third layer of the neural network model to obtain scored query data in the operation S940. Then, an element wise product of the scored query data and the key data is performed to obtain an attention weight in the operation S950. Then, an element wise product of the attention weight and the value data is performed to obtain context data in the operation S960. Then, the context data and the query data are input into a fourth layer of the neural network model to obtain an object separation mask in the operation S970. Then, the object separation mask is converted into a time domain to obtain an audio object included in the audio data in the operation S980. Here, the audio data converted into the frequency domain may be in the form of one-dimensional data, and the encoded data, the query data, the key data, the value data, the scored query data, the attention weight, and the context data may be in the form of one-dimensional data in the same size.

Also, the first layer may include a fully connected layer and a first activation layer, and in the operation S920 of obtaining the encoded data, the audio data converted into the frequency domain may be sequentially input into the fully connected layer and the first activation layer to obtain the encoded data, and the first activation layer may be implemented as one of an ReLU or a sigmoid.

Meanwhile, the second layer may include a query generation layer, a key generation layer, and a value generation layer, and in the operation S930 of obtaining the query data, the key data, and the value data, an element wise product of the encoded data with each of the query generation layer, the key generation layer, and the value generation layer may be performed to obtain the query data, the key data, and the value data.

Also, the query data may be in the form of 1×Fs, and include Fs frequency components, and the third layer may be in the form of Fs×Fs, and in the operation S940 of obtaining the scored query data, the query data may be input into the third layer to obtain the scored query data in the form of 1×Fs, and in the operation S950 of obtaining the attention weight, an element wise product of the scored query data and the key data may be performed to obtain the attention weight based on frequency components.

Meanwhile, in the operation S960 of obtaining the context data, an element wise product of the attention weight and the value data may be performed to obtain the context data to which weights of frequency components are reflected.

Also, the fourth layer may include a decoding layer and a second activation layer, and in the operation S970 of obtaining the object separation mask, the context data and the query data may be combined to obtain combined data in the form of 1×2Fs, and the combined data may be sequentially input into the decoding layer and the second activation layer to obtain the object separation mask, and the second activation layer may be implemented as one of an ReLU or a sigmoid.

Meanwhile, the control method may further include the operation of receiving an audio signal, and in the operation S910 of converting, time axis audio data in a predetermined number in the audio signal may be sequentially converted into the frequency domain.

Here, in the operation S910 of converting, the time axis audio data in the predetermined number in the audio signal may be sequentially converted into the frequency domain by overlapping the audio data in a ratio of 50%.

Also, in the operation S910 of converting, fast fourier transform (FFT) of the audio data may be performed to convert the audio data into the frequency domain, and in the operation of obtaining the audio object, inverse FFT of the object separation mask may be performed to convert the mask into the time domain.

Meanwhile, the neural network model may be a model that was obtained by learning a relation between a plurality of sample audio signals and a plurality of sample audio objects, and each of the plurality of sample audio signals may include a sample audio object and a sample noise corresponding to each of the plurality of sample audio signals among the plurality of sample audio objects.

According to the aforementioned various embodiments of the disclosure, an electronic device can separate an audio object in real time with high performance by using single frame audio data of the current time section.

Also, an electronic device can separate an audio object in real time without a limitation on hardware characteristics, and can reduce the manufacturing cost and improve the operation speed.

Meanwhile, according to an embodiment of the disclosure, the aforementioned various embodiments may be implemented as software including instructions stored in machine-readable storage media, which can be read by machines (e.g.: computers). The machines refer to devices that call instructions stored in a storage medium, and can operate according to the called instructions, and the devices may include an electronic device according to the aforementioned embodiments (e.g.: an electronic device A). In case an instruction is executed by a processor, the processor may perform a function corresponding to the instruction by itself, or by using other components under its control. An instruction may include a code that is generated or executed by a compiler or an interpreter. A storage medium readable by machines may be provided in the form of a non-transitory storage medium. Here, the term ‘non-transitory’ only means that the storage medium does not include signals and is tangible, and the term does not distinguish a case wherein data is stored in the storage medium semi-permanently and a case wherein data is stored temporarily.

Also, according to an embodiment of the disclosure, the method according to the aforementioned various embodiments may be provided while being included in a computer program product. A computer program product refers to a product, and it can be traded between a seller and a buyer. A computer program product can be distributed in the form of a storage medium that is readable by machines (e.g.: compact disc read only memory (CD-ROM)), or distributed on-line through an application store (e.g.: Play Store™M). In the case of on-line distribution, at least a portion of a computer program product may be stored in a storage medium such as the server of the manufacturer, the server of the application store, and the memory of the relay server at least temporarily, or may be generated temporarily.

In addition, according to an embodiment of the disclosure, the aforementioned various embodiments may be implemented in a recording medium that is readable by a computer or a device similar thereto, by using software, hardware, or a combination thereof. In some cases, the embodiments described in this specification may be implemented as a processor itself. According to implementation by software, the embodiments such as procedures and functions described in this specification may be implemented as separate software. Each software may perform one or more functions and operations described in this specification.

Meanwhile, computer instructions for performing processing operations of machines according to the aforementioned various embodiments may be stored in a non-transitory computer-readable medium. Computer instructions stored in such a non-transitory computer-readable medium make the processing operations at machines according to the aforementioned various embodiments performed by a specific machine, when the instructions are executed by the processor of the specific machine. A non-transitory computer-readable medium refers to a medium that stores data semi-permanently, and is readable by machines, but not a medium that stores data for a short moment such as a register, a cache, and memory. As specific examples of a non-transitory computer-readable medium, there may be a CD, a DVD, a hard disk, a blue-ray disk, a USB, a memory card, ROM and the like.

Also, each of the components according to the aforementioned various embodiments (e.g.: a module or a program) may consist of a singular object or a plurality of objects, and among the aforementioned corresponding sub components, some sub components may be omitted, or other sub components may be further included in the various embodiments. Alternatively or additionally, some components (e.g.: a module or a program) may be integrated as an object, and perform functions performed by each of the components before integration identically or in a similar manner. Further, operations performed by a module, a program, or other components according to the various embodiments may be executed sequentially, in parallel, repetitively, or heuristically. Or, at least some of the operations may be executed in a different order or omitted, or other operations may be added.

In addition, while preferred embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Further, it is intended that such modifications are not to be interpreted independently from the technical idea or prospect of the disclosure.

1. An electronic device comprising:
a memory to store a neural network model; and
at least one processor, to be connected with the memory, configured to control the electronic device to:
convert audio data into a frequency domain,
obtain encoded data by inputting the audio data converted into the frequency domain into a first layer of the neural network model,
obtain query data, key data, and value data by inputting the encoded data into a second layer of the neural network model,
obtain scored query data by inputting the query data into a third layer of the neural network model,
obtain an attention weight by performing an element wise product of the scored query data and the key data,
obtain context data by performing an element wise product of the attention weight and the value data,
obtain an object separation mask by inputting the context data and the query data into a fourth layer of the neural network model, and
obtain an audio object included in the audio data by converting the object separation mask into a time domain,
wherein the audio data converted into the frequency domain is in a form of one-dimensional data, and
the encoded data, the query data, the key data, the value data, the scored query data, the attention weight, and the context data are in the form of one-dimensional data having a size that is same.

2. The electronic device of claim 1,
wherein the first layer comprises:
a fully connected layer and a first activation layer, and
the at least one processor is configured to:
obtain the encoded data by sequentially inputting the audio data converted into the frequency domain into the fully connected layer and the first activation layer, and
the first activation layer is implemented as one of an ReLU or a sigmoid.

3. The electronic device of claim 1,
wherein the second layer comprises:
a query generation layer, a key generation layer, and a value generation layer, and
the at least one processor is configured to:
obtain the query data, the key data, and the value data by performing an element wise product of the encoded data with the query generation layer, the key generation layer, and the value generation layer, respectively.

4. The electronic device of claim 1,
wherein the query data is in a form of 1×Fs, and includes Fs frequency components, and
the third layer is in a form of Fs×Fs, and
the at least one processor is configured to:
obtain the scored query data in the form of 1xFs by inputting the query data into the third layer, and
obtain the attention weight based on frequency components by performing an element wise product of the scored query data and the key data.

5. The electronic device of claim 1,
wherein the at least one processor is configured to:
obtain the context data to which weights of frequency components are reflected by performing an element wise product of the attention weight and the value data.

6. The electronic device of claim 1,
wherein the fourth layer comprises:
a decoding layer and a second activation layer, and
the at least one processor is configured to:
obtain combined data in the form of 1×2Fs by combining the context data and the query data, and
obtain the object separation mask by sequentially inputting the combined data into the decoding layer and the second activation layer, and
the second activation layer is implemented as one of an ReLU or a sigmoid.

7. The electronic device of claim 1, further comprising:
a communication interface,
wherein the at least one processor is configured to:
based on receiving an audio signal through the communication interface, sequentially convert time axis audio data in a predetermined number in the audio signal into the frequency domain.

8. The electronic device of claim 7,
wherein the at least one processor is configured to:
sequentially convert the time axis audio data in the predetermined number in the audio signal into the frequency domain by overlapping the audio data in a ratio of 50%.

9. The electronic device of claim 1,
wherein the at least one processor is configured to:
convert the audio data into the frequency domain by performing fast fourier transform (FFT) of the audio data, and
convert a mask into the time domain by performing inverse FFT of the object separation mask.

10. The electronic device of claim 1,
wherein the neural network model is obtained by learning a relation between a plurality of sample audio signals and a plurality of sample audio objects, and
the plurality of sample audio signals respectively comprise:
a sample audio object and a sample noise corresponding to the plurality of sample audio signals, respectively.

11. A control method of an electronic device, the control method comprising:
converting audio data into a frequency domain;
obtaining encoded data by inputting the audio data converted into the frequency domain into a first layer of a neural network model;
obtaining query data, key data, and value data by inputting the encoded data into a second layer of the neural network model;
obtaining scored query data by inputting the query data into a third layer of the neural network model;
obtaining an attention weight by performing an element wise product of the scored query data and the key data;
obtaining context data by performing an element wise product of the attention weight and the value data;
obtaining an object separation mask by inputting the context data and the query data into a fourth layer of the neural network model; and
obtaining an audio object included in the audio data by converting the object separation mask into a time domain,
wherein the audio data converted into the frequency domain is in a form of one-dimensional data, and
the encoded data, the query data, the key data, the value data, the scored query data, the attention weight, and the context data are in the form of one-dimensional data having a size that is same.

12. The control method of claim 11,
wherein the first layer comprises:
a fully connected layer and a first activation layer, and
the obtaining the encoded data comprises:
obtaining the encoded data by sequentially inputting the audio data converted into the frequency domain into the fully connected layer and the first activation layer, and
the first activation layer is implemented as one of an ReLU or a sigmoid.

13. The control method of claim 11,
wherein the second layer comprises:
a query generation layer, a key generation layer, and a value generation layer, and
the obtaining the query data, the key data, and the value data comprises:
obtaining the query data, the key data, and the value data by performing an element wise product of the encoded data with each of the query generation layer, the key generation layer, and the value generation layer.

14. The control method of claim 11,
wherein the query data is in the form of 1×Fs, and includes Fs frequency components, and
the third layer is in the form of Fs×Fs, and
the obtaining the scored query data comprises:
obtaining the scored query data in the form of 1×Fs by inputting the query data into the third layer, and
the obtaining the attention weight comprises:
obtaining the attention weight based on frequency components by performing an element wise product of the scored query data and the key data.

15. The control method of claim 11,
wherein the obtaining the context data comprises:
obtaining the context data to which weights of frequency components are reflected by performing an element wise product of the attention weight and the value data.
